(19) United States
(12) Patent Application Publication
(10) Pub. No.: US 2003/0154288 A1
(43) Pub. Date: Aug. 14, 2003

(54) Server-client system and data transfer method used in the same system

(75) Inventors: Akihiro Takamura, Koganei (JP); Yoshio Miki, Kodaira (JP); Hiroaki Fujii, Tokorozawa (JP); Tatsuya Kawashimo, Kokubunji (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/197,412

(22) Filed: Jul. 18, 2002

(30) Foreign Application Priority Data
Feb. 14, 2002 (JP) 2002-036127

(51) Int. Cl. G06F 15/16

(52) U.S. Cl. 709/227; 709/203

(57) ABSTRACT

In a server-client system, data transmitted by an application of a client computer is stored in a client computer. Whether an application of a server computer terminates normally is reported to the client computer. When the application does not terminate normally, the stored data is retransmitted to another server computer.

### BACKGROUND OF THE INVENTION

The present invention relates to a server-client system for taking over a portion of information processing via a network wherein failure of an information processing apparatus of a server computer or an abnormal termination of an application process does not affect an application operation of a client computer.

A server-client system for taking over a portion of information processing via a network widely uses a retransmission processing for again transmitting data which has been transmitted once, so as to recover lost data when information is lost. One of the embodiments of the retransmission processing is a TCP/IP protocol. The TCP/IP protocol is used for performing a communication of high reliability (data communication without losing data) in a network of low reliability (data may be lost). In the TCP/IP protocol, retransmission is performed unless a response to the transmitted data is obtained within a predetermined time. Even if a data loss is caused by a temporary hardware failure in the network, by performing retransmission, it is possible not to exhibit the affect of hardware failure to an application using the TCP/IP protocol. However, even when the TCP/IP protocol is used, a failure in the communication destination and a fixed failure in the network may be exhibited in the application. For these failures, conventionally, retransmission is required in the application side to another server computer. However, retransmission at the application side has problems that a number of the development steps is increased and that it is difficult to create an application so as to correctly operate at all the timings when a failure is caused. To cope with this, U.S. Pat. No. 5,907,676 discloses in idea that a communication destination is virtualized and when a failure is caused, necessary data is retransmitted to another communication destination, so that the failure at the communication destination does not affect the application.

However, in the aforementioned conventional technique, for an abnormal termination of the application or a failure at the communication destination after a communication is terminated, the application should solve the problem.

### SUMMARY OF THE INVENTION

It is therefore an object of the present invention to provide a system in which an application is not affected even if a failure occurs at a communication destination or an application of the communication destination abnormally terminates at any timing between the communication start and termination of the application of the communication destination.

In order to achieve the aforementioned object, according to the present invention, data transmitted by a client computer application is stored and a determination whether a server computer application terminates normally is transmitted to the client computer. Thus, when the server computer application has not terminated normally, data can be retransmitted to another server computer. That is, even an error has occurred in the server computer, processing of the client computer can be continued.

Furthermore, the present invention determines whether a server computer application terminates normally in the processing starting the server computer application. Thus, without modifying the server computer application, when the server computer application has not terminated normally, data can be retransmitted to another server computer. That is, even if an error has occurred in the server computer, processing of the client computer can be continued.

Furthermore, according to the present invention, a shared library performs storing of data transmitted by the client computer application and retransmission when a server computer has failed. Thus, without modifying the client computer application, when the server computer application has not terminated normally, data can be retransmitted to another server computer. That is, even if the server computer fails, the processing of the client computer can be continued.

Furthermore, the present invention checks whether a function is provided for notifying a client computer that the server computer application has terminated normally and stores data transmitted by the client computer application only when such mechanism is provided. Thus, it is possible to constitute a system including a server having this mechanism and a server not having this mechanism. If the server computer where an error has occurred has this mechanism, processing of the client computer can be continued.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a computer system according to a first embodiment.

FIG. 2 shows memory configuration of a client computer in the first embodiment.

FIG. 3 shows memory configuration of a server computer in the first embodiment.

FIG. 4 is a processing flowchart of an application of the client computer in the first embodiment.

FIG. 5 is a processing flowchart of an application of the server computer in the first embodiment.

FIG. 6 is a processing flowchart of a communication socket fetch in the first embodiment.

FIG. 7 is a processing flowchart of a communication start in the first embodiment.

FIG. 8 is a processing flowchart of data transmission in the first embodiment.

FIG. 9 is a processing flowchart of data reception in the first embodiment.

FIG. 10 is a processing flowchart of communication termination in the first embodiment.

FIG. 11 is a processing flowchart of data retransmission in the first embodiment.

FIG. 12 shows configuration of a communication buffer in the first embodiment.

FIG. 13 shows configuration of a socket number correspondence table in the first embodiment.

FIG. 14 is a processing flowchart of end confirmation reception in the first embodiment.

FIG. 15 is a processing flowchart of end confirmation in the first embodiment.

FIG. 16 shows configuration of a server computer memory according to a second embodiment.

FIG. 17 is a processing flowchart of application start in the second embodiment.

FIG. 18 is a processing flowchart of signal interruption in the second embodiment.

FIG. 19 is a processing flowchart of a server computer application in the second embodiment.

FIG. 20 is a block diagram showing a computer system according to a third embodiment.

FIG. 21 shows memory configuration of a client computer in the third embodiment.

FIG. 22 shows configuration of a secondary memory device of the client computer in the second embodiment.

FIG. 23 is a processing flowchart of application of the client computer in the third embodiment.

FIG. 24 shows configuration of a memory of a client computer according to a fourth embodiment.

FIG. 25 shows configuration of a server function table of the fourth embodiment.

FIG. 26 is a processing flowchart of confirmation function check decision in the fourth embodiment.

FIG. 27 is processing flowchart of data transmission in the fourth embodiment.

FIG. 28 is processing flowchart of data reception in the fourth embodiment.

FIG. 29 is a processing flowchart of communication termination in the fourth embodiment.

### DESCRIPTION OF THE EMBODIMENTS

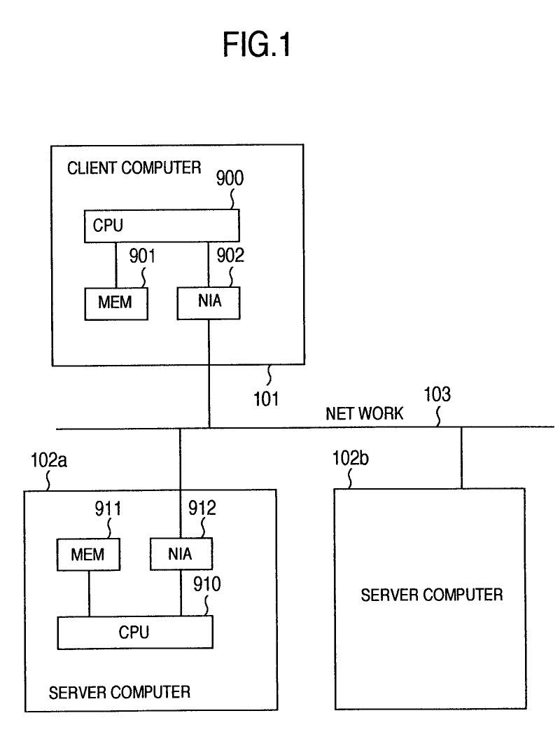

FIG. 1 is a computer system according to a first embodiment. The computer system according to the first embodiment includes one or more client computers 101, two or more server computers 102a, 102b, and a network 103 connecting these computers to one another. The client computer 101 consists of a memory 901 for storing a program and data, a processor 900 for performing processing in accordance with the program in the memory 901, and an NIA (network interface adapter) 902 for connection to the network. Similarly, the server computers 102a and 102b consist of a memory 911 for storing a program and data, a processor 910 for performing processing in accordance with the program in the memory 911, and an NIA (network interface adapter) 912 for connection to the network. It should be noted that this system configuration is common to a second and a fourth embodiment which will be detailed later.

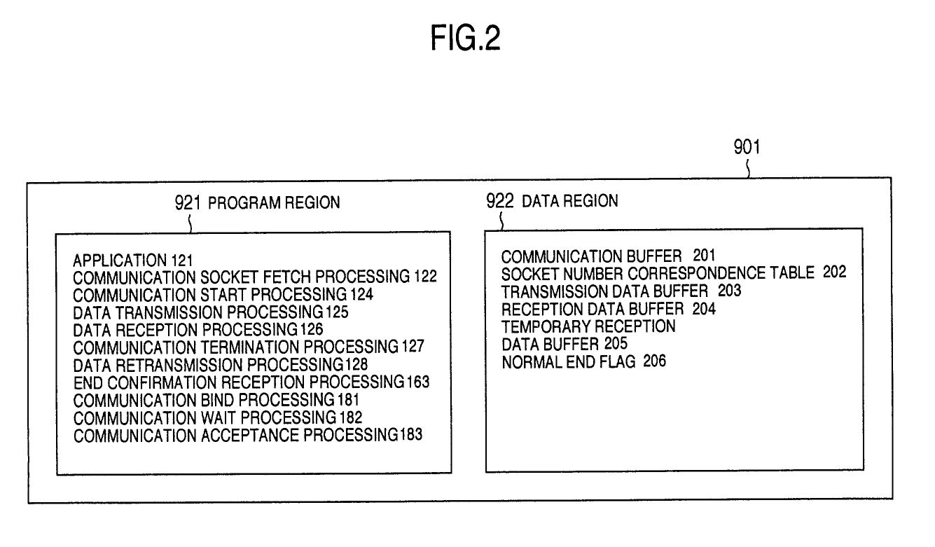

FIG. 2 shows configuration of the memory 901 of the client computer 101. The memory 901 has a program region 921 for storing programs executed by a processor 900 of the client computer 101 of FIG. 1 and a data region 922 for storing data used by the programs executed by the processor 900 of the client computer 101 of FIG. 1.

The program region 921 contains: an application 121 for communicating with an application 131 of the server computer 102a and 102b via the network 103; programs called from the application 121 for performing communication with the server computer including a communication socket fetch processing 122, a communication start processing 124, a data transmission processing 125, a data reception processing 126, and a communication termination processing 127; a data retransmission processing 128 called from the data transmission processing 125, the data reception processing 126, and the communication termination processing 127 for retransmitting data which has been transmitted, to another server computer when an error has occurred in the server computer or the application of the server computer has terminated abnormally; and an end confirmation reception processing 163 called from the communication termination processing 127 for receiving from the server computer data on whether an error has occurred in the server computer or the application of the server computer has terminated abnormally.

The data region 922 contains: a communication buffer 201 for storing the call order of the data transmission processing 125 and the data reception processing 126 and transmission data when the transmission processing is called; socket number correspondence table 202 storing correspondence between a communication socket number (virtual socket number) used by the application 121 and a socket number (actual socket number) actually used for communication; a transmission data buffer 203 used for data transmission by the application 121 of the client computer 101; a reception data buffer 204 used for data reception by the application 121 of the client computer 101; a temporary reception data buffer 205 used by the data retransmission processing 128 of the client computer 101; and a normal end flag 206 used by the end confirmation reception processing 163 of the client computer 101.

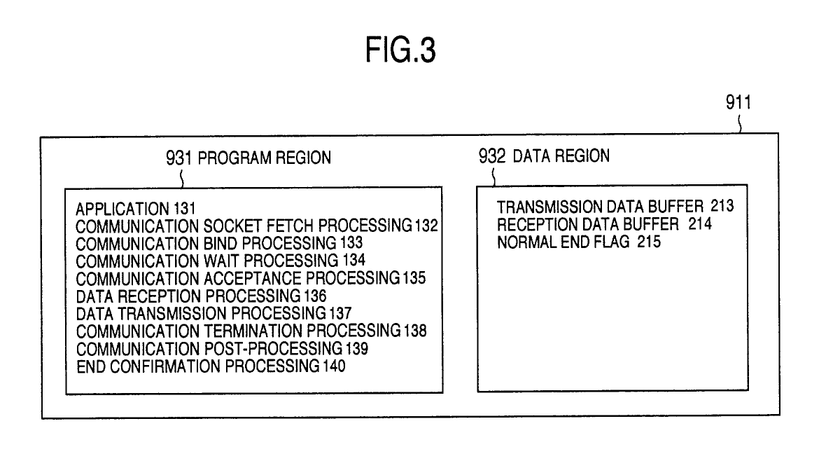

FIG. 3 shows configuration of the memory 911 of the server computer 102a and 102b of FIG. 1. The memory 911 has a program region 931 for storing a program executed by the processor 910 of the server computer 102a and 102b and a data region storing data used by the program executed by the processor 910. The program region 931 contains: an application 131 communicating with the application 121 of the client computer 101 via the network 103; and a communication socket fetch processing 132, a communication bind processing 133, a communication wait processing 134, a communication acceptance processing 135, a data reception processing 136, a data transmission processing 137, a communication termination processing 138, a communication post-processing 139, and an end confirmation processing 140 which are called by the application 131 for executing communication with the server computer. The data region 932 contains: a transmission data buffer 213 used by the application 131 of the server computers 102a and 102b when transmitting data; a reception data buffer 214 used when data is received; and a normal end flag 215 used by the end confirmation processing.

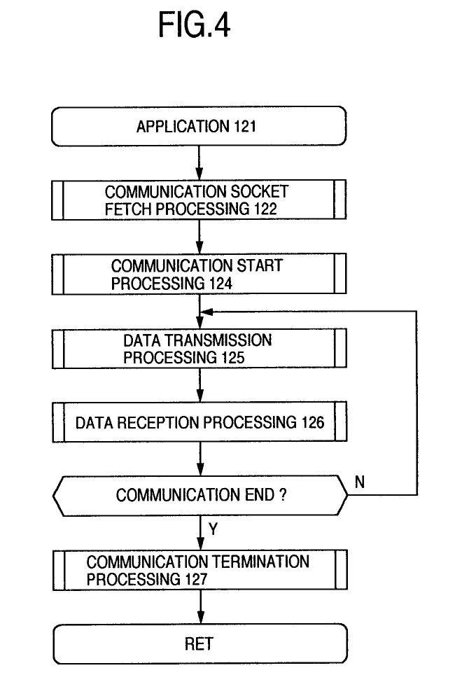

FIG. 4 shows processes of the application 121 executed by the client computer used in the first embodiment and related to the present invention. When performing communication, the application 121 of the client computer 101 calls the communication socket fetch processing 122 using the communication protocol (TPC/IP) as an argument and fetches a communication socket number used to specify a server computer to communicate with, its application, and a communication stream. Furthermore, for establishing a communication, the communication start processing 124 is called by using the communication socket number, an IP address, and a port number as arguments. Furthermore, for transferring data required for processing by the server computer, the data transmission processing 125 is called by using the communication socket number, an address of the transmission data buffer 203 of the memory 901 of the client computer 101, and a data length of the transmission data buffer 203 as arguments. The data transmission processing 125 of the client computer 101 is executed and the data reception processing 136 is executed in the server computer 102a. Then, data stored in the transmission data buffer 203 of the memory 901 of the client computer 101 is transferred via the NIA 902 of the client computer 101, the network 103, and the NIA 912 of the server computer 102a to the reception data buffer 214 of the memory 911 of the server computer 102a.

Furthermore, in order to receive a result of processing in the server computer 102a, the data reception processing 126 is called by using the communication socket number, an address of the reception data buffer 204 of the memory 901 of the client computer 101, and a length of data to be received as arguments. The data transmission processing 137 is executed in the server computer 102a and the data reception processing 126 is executed in the client computer 101. Then, the data stored in the transmission buffer 213 of the memory 911 of the server computer 102a is transferred via the NIA 912 of the server computer 102a, the network 103, and NIA 902 of the client computer 101 to the reception data buffer 204 of the memory 901 of the client computer 101.

The data transmission processing 125 and the data reception processing 126 are repeated as is required. When communication is performed a necessary number of times, the communication termination processing 127 is called by using the socket number as an argument so as to terminate the communication.

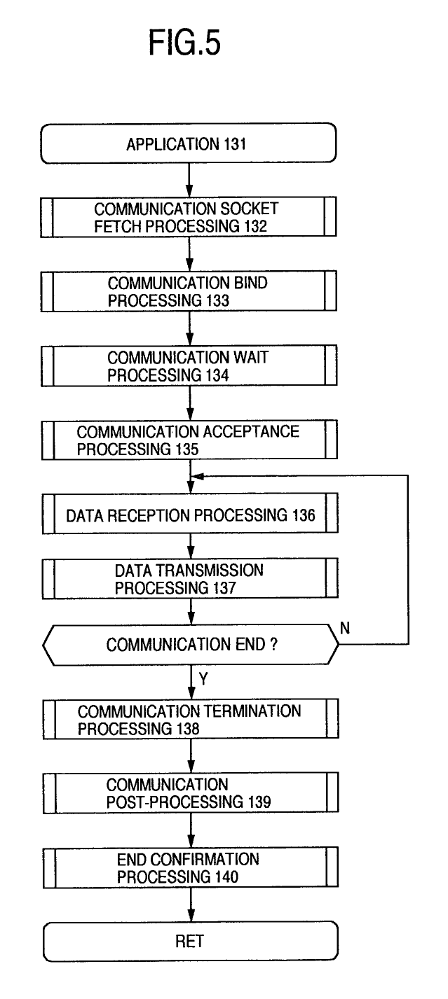

FIG. 5 shows processes of the application 131 executed by the server computer 102a and 102b used in the first, third, and fourth embodiments and related to the present invention.

Firstly, when performing communication, the communication socket fetch processing 132 is called by using the communication protocol (TCP/IP) as the argument and a communication number is fetched to be used to specify a client computer to communicate with, its application, and a communication stream. Next, in order to specify an IP address and a port number for performing reception, the communication bind processing 133 is called by using the communication socket number, the IP address, and the port number as arguments. It should be noted that when the IP address for performing reception is arbitrary, it is specified that the IP address is arbitrary. When the port number is arbitrary, it is specified that the port number is arbitrary. Furthermore, in order to perform the connection wait from the client computer 101, the communication wait processing 134 is called by using the socket number as the argument. Furthermore, the communication acceptance processing 135 is called and a socket number whose connection with the client is complete is received as a return value. Furthermore, in order to receive the processing content required by the client computer, the data reception processing 136 is called by using the connection-completed socket number, an address of the reception data buffer 214 of the memory 911, and a length of data to be received as arguments. The data transmission processing 125 of the client computer 101 is executed and the data reception processing 136 is executed in the server computer. Thus, the data stored in the transmission data buffer 203 of the memory 901 of the client computer 101 is transferred via the NIA 902 of the client computer 101, the network 103, and the NIA 912 of the server computer to the reception data buffer 214 of the memory 911.

Furthermore, in order to transfer a result of processing in the server computer to the client computer, a connection-completed socket number, an address of the transmission data buffer 213 of the memory 911, and a data length stored in the transmission data buffer 213 are specified and the data transmission processing 137 is called. The data transmission processing 1137 is executed in the server computer and the data reception processing 126 is executed in the client computer. Thus, the data stored in the transmission data buffer 213 of the memory 911 is transferred via the NIA 912 of the server computer, the network 103, and the NIA 902 of the client computer 101 to the reception data buffer 204 of the memory 901 of the client computer 101.

The data reception processing 136 and the data transmission processing 137 are repeated as is required. When communication has been performed a necessary number of times, in order to terminate the communication, the communication termination processing 138 is called by using the connection-completed socket number as the argument. The communication post-processing 139 differs depending on the application and represent processes performed after completion of the communication termination processing 138 until the end confirmation processing 140 is called. For example, in case of database processing, write to a disc after the communication end or in case of processing in a mail server, if a mail destination is another server computer, a mail transmission to that server computer, if a mail destination is a local computer, a mail writing to a disc.

When the server computer fails after the communication end or an application operating in the server computer terminates abnormally, this cannot be reported to the client computer in the conventional method because the communication has been terminated. To cope with this, in the present embodiment, by using the end confirmation processing 140, an error which has occurred not only during the communication but also immediately before the application end and abnormal termination in the application are reported to the client computer. More specifically, when the application terminates normally (the return value of the application 131 is 0), the end confirmation processing is called by using 0 as an argument and when an error has occurred or the application does not terminate normally (the return value of the application 131 is other than 0), the end confirmation processing 140 is called by using an argument other than 0.

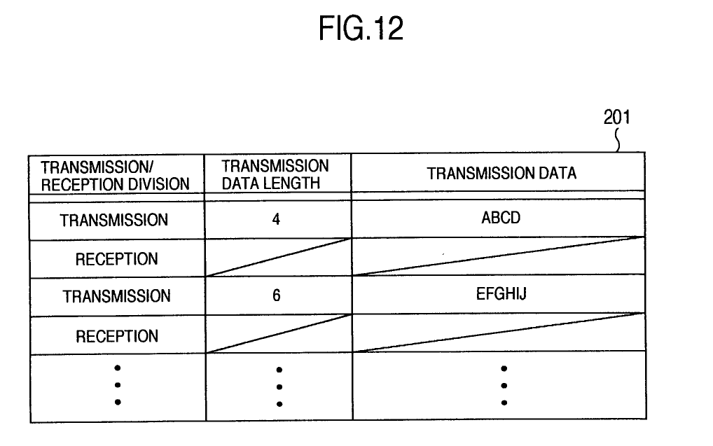

FIG. 12 shows configuration of a communication buffer 201 in the memory 901 of the client computer 101. The communication buffer 201 consists of a transmission/reception division, a transmission data length, and transmission data. In the communication buffer 201, information is stored in the order of calling the data transmission processing 125 or the data reception processing 126 by the application 121 of the client computer 101. The transmission/reception division shows which of the data transmission processing 125 and the data reception processing has been called by the application 121 of the client computer 101. Furthermore, when the data transmission processing 125 is called, in the transmission data of the communication buffer 201, the data stored in the transmission data buffer 203 is stored by the data length of the transmission data buffer 203.

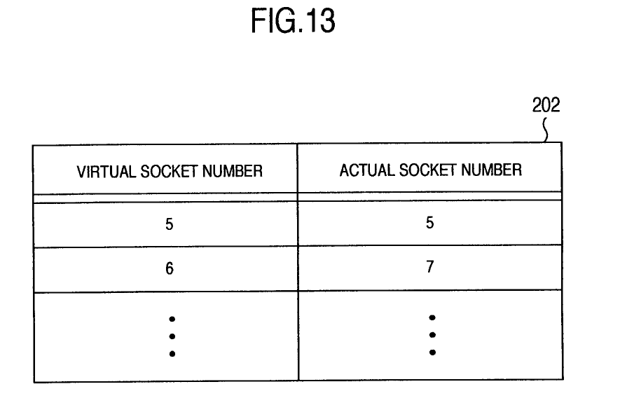

FIG. 13 shows configuration of a socket number correspondence table 202 in the memory 901 of the client computer 101. The socket number correspondence table 202 contains correspondence between a communication socket number (virtual socket number) used by the application 121 of the client computer 101 and a socket number (actual socket number) actually used for communication with the server computer.

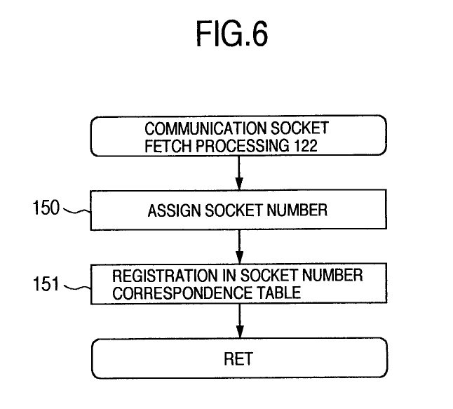

FIG. 6 is a flowchart of the communication socket fetch processing 122 present in the memory 901 of the client computer 101 and called by the application 121. Firstly, in step 150, a socket number is allocated by specifying the communication protocol (TCP/IP) given as an argument. In the conventional method, the processing is terminated using the socket number obtained by socket number allocation as a return value. However, in the present embodiment of the invention, when an error has occurred in the server computer or the application of the server computer has terminated abnormally, the application 121 of the client computer 101 keeps using the previous socket number and uses a communication socket to another server, thereby continuing the communication. For this, correspondence between a socket number (hereinafter, referred to as a virtual socket number) used by the application 121 and the communication start processing 124 and a socket number (hereinafter, referred to as an actual socket number) used by the data transmission processing 125, the data reception processing 126, and the communication termination processing 127 should be managed by the socket number correspondence table 202 of the memory 901 of the client computer 101. In step 151, as an initial state, the virtual socket number and the actual socket number are made identical. That is, the virtual socket number is a socket number fetched by the socket number allocation 150 and the actual socket number is also a socket number fetched by the socket number allocation 150. This correspondence is stored in the memory 902 of the client computer 101. Furthermore, the process is terminated by using the socket number fetched by the socket number allocation 150 as a return value.

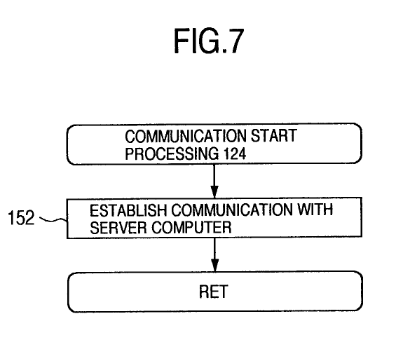

FIG. 7 is a flowchart of the communication start processing 124 present in the memory 901 of the client computer 101 of FIG. 1 and called by the application 121. In the communication start processing 124, like in the conventional method, a socket number, an IP address, and a port number are received as arguments. In step 152, communication is established with an application of a server computer having the IP address and the port number specified by the arguments.

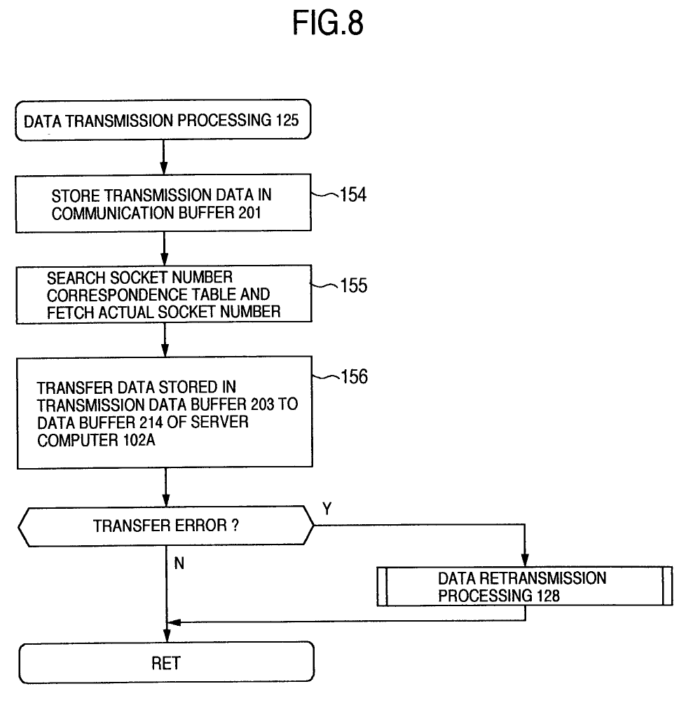

FIG. 8 shows a processing flow of the data transmission processing 125 present in the memory 901 of the client computer and called by the application 121.

The data transmission processing 125 receives a communication socket number, an address of the data buffer 203 of the memory 901 of the client computer 101, and a data length stored in the transmission data buffer 203 as arguments and transmits a content of the transmission data buffer by the data length of the data buffer to the application of a server computer specified by the communication socket number. Here, the content transmitted to the server computer is stored in the communication buffer 201. Accordingly, when the application of the server computer terminates abnormally, data can be transmitted to another server computer, so as to continue communication of the application of the client computer. Hereinafter, this procedure will be detailed.

Firstly, in step 154, transmission is stored in the column of the transmission/reception division of the communication buffer 201 of the memory 901 of the client computer 101. Moreover, in the column of the transmission data length, the data length specified by the argument is stored. In the column of the transmission data, the data stored in the transmission data buffer 203 is stored. Next, in step 155, the socket number correspondence table is searched by using as a virtual socket number the communication socket number received as the argument and an actual socket number is fetched. Furthermore, in step 156, the data stored in the transmission data buffer 203 is transferred to a server computer specified by the actual socket number. The server computer of the transfer destination receives the data in the reception data buffer 214 of the memory 911. Furthermore, if an error occurs in the transfer in step 156, the data transmission processing 128 is called so as to transmit the content which has been transmitted, to another server.

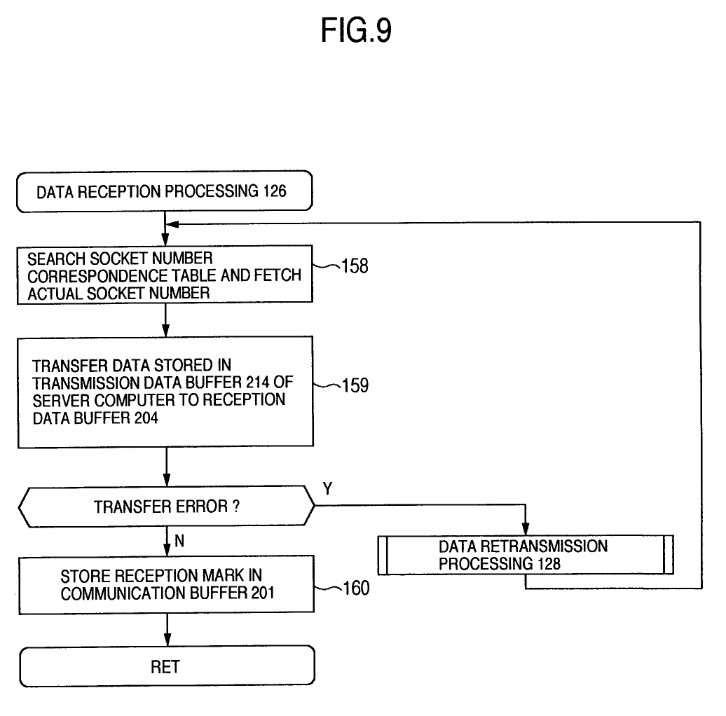

FIG. 9 shows a processing flow of the data reception processing 126 called from the application 121. Firstly, in step 158, the socket number correspondence table 202 is searched by using as a virtual socket number the communication socket number received as the argument and an actual socket number is fetched. Next, in step 159, data transferred by the data transfer processing 137 of the server computer specified by the actual socket number is transferred to the reception data buffer 204 of the memory 901. Furthermore, if an error occurs in the communication of step 159, the data retransmission processing 128 is called so as to transmit a content which has been transmitted, to another server and the data reception processing 126 is re-executed from the beginning. Furthermore, the reception is stored in the column of the transmission/reception division.

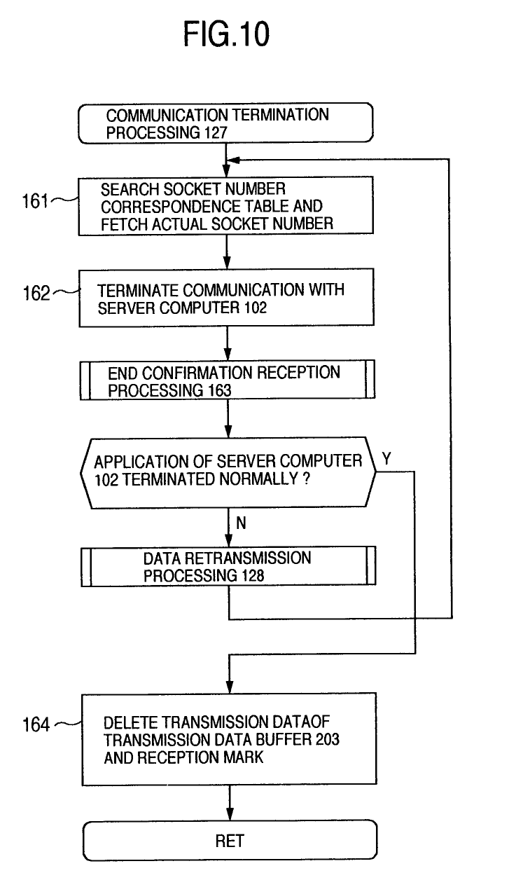

FIG. 10 shows a processing flow of the communication termination processing 127 called from the application 121. Firstly, in step 161, the socket number correspondence table 202 is searched by using as a virtual socket number the communication socket number received as the argument and an actual socket number is fetched. Next, in step 162, communication with the server computer 102 corresponding to the actual socket number is terminated. Furthermore, the end confirmation reception processing 163 inherent to the present invention is called so as to receive a report whether the application has terminated normally, from the end confirmation processing 140 of the server computer 102. If the end confirmation reception processing 163 returns 0 (the application has terminated normally) as a return value, then the transmission/reception division, the transmission data length, and the transmission data stored in the communication buffer 201 in step 164 are deleted and the processing is terminated. If the end confirmation reception processing 163 returns other than 0 (the application has not terminated normally) as a return value, then like a case when a transfer error is detected in the data transmission processing (FIG. 8) and the data reception processing (FIG. 9), the data retransmission processing 128 is called so as to retransmit data to another normal server computer. When this retransmission is completed, the communication termination processing 127 is executed from the beginning.

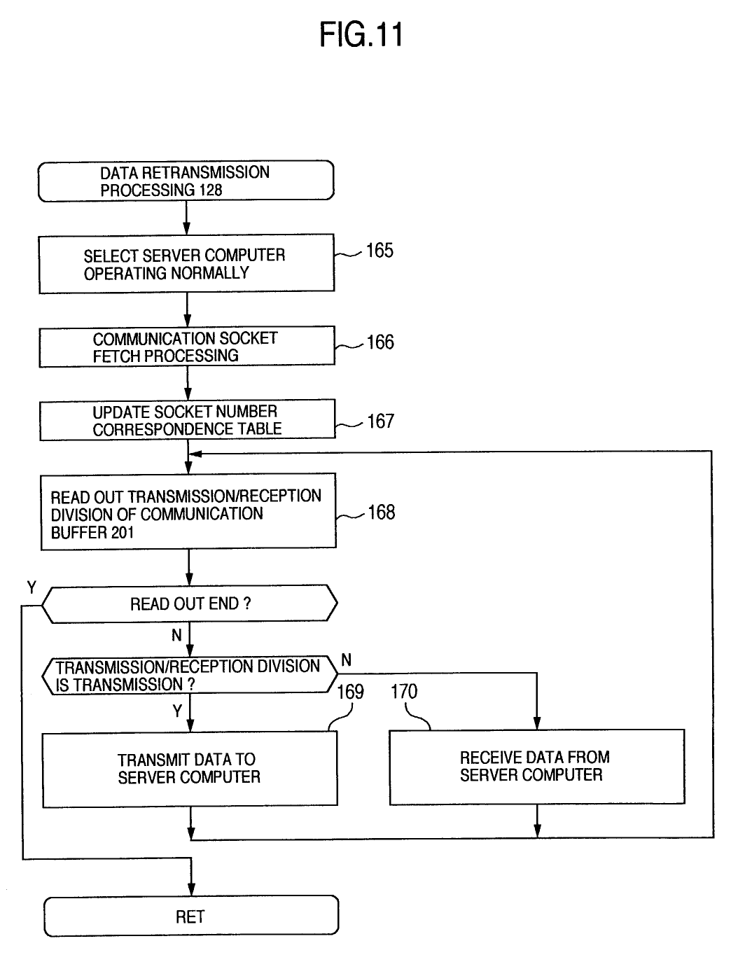

FIG. 11 shows a processing flow of the data retransmission processing 128 present in the memory 901 of the client computer 101 and called from the data transmission processing 124, the data reception processing 125, and the communication termination processing 126. Firstly, step 165 checks whether a response to the ping command is present in the server computers 102a and 102b and a server computer normally operating is selected from the server computers 102a and 102b. In this embodiment, it is assumed that an error has occurred in the server computer 102a which has been performing communication. Accordingly, in step 165, the server computer 102b is selected. Next, the communication socket fetch processing 166 is called by using the communication protocol (TCP/IP) as the argument and a communication socket number is fetched. Furthermore, in step 167, the socket number correspondence table is searched by using as a virtual socket number the socket number fetched in the communication socket fetch processing 122 in the application 101 and a corresponding actual socket number is modified to the communication socket number fetched by the communication socket fetch processing 166 in the data retransmission processing 128. Furthermore, in step 168, in the order of storing in the communication buffer 201, the transmission/reception division is read out. When the read out is complete, the data retransmission processing 128 is terminated. When the transmission/reception division is transmission, control is passed to step 169, where by using the communication socket number fetched by the communication socket fetch processing 166, transmission data of the communication buffer 201 of the memory 901 of the client computer 101 is transmitted by the transmission data length of the communication buffer 201, to the reception buffer 214 of the memory 911 specified by the data reception processing 136 of the application 131 of the server computer 102b. When the transmission/reception division is reception, control is passed to step 170, where by using the communication socket number fetched by the communication socket fetch processing 166, a content of the transmission data buffer 213 of the memory 911 specified by the data transmission processing 137 of the application 131 of the server computer 102b is received by the temporary reception data buffer 204 of the memory 901 of the client computer 101.

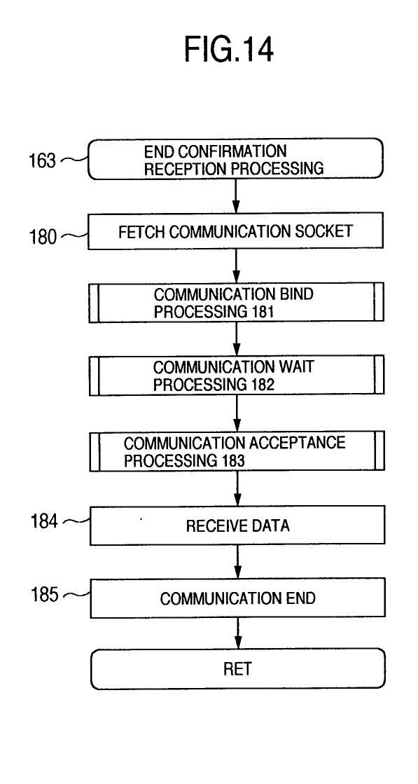

FIG. 14 shows a processing flow of the end confirmation reception processing 163 called from the communication termination processing 127. The end confirmation reception processing 163 receives a report whether the application has terminated normally, from the end confirmation processing 140 of the server computer 102 and returns the value as a return value. Hereinafter, this procedure will be detailed.

Firstly, communication with a server computer is established. That is, in step 180, a communication socket number is fetched. And in order to specify an IP address and a port number for performing reception, the communication socket number and the IP address are used as arguments and the communication bind processing 181 is called. To perform a connection wait from the server computer 102a, the communication wait processing 182 is called by using the communication socket number as the argument. Next, a communication acceptance processing 183 is called and an IP address and a port number of the communication destination are fetched. Step 184 specifies the socket number and specifies the normal end flag 206 of the memory 901 to the reception destination, thereby performing data reception. When a data transmission processing 193 (which will be detailed later) is executed in the server computer 102a, step 184 is executed in the client computer 101 and data of the normal end flag 215 indicating whether the application of the server computer 102a has terminated normally is transferred via the network 103 and the NIA 902 of the client computer 101 to the normal end flag 206 of the memory 901 of the client computer 101. Furthermore, in step 185, communication with the server computer 102a is terminated. The aforementioned end confirmation reception processing 163 is terminated with the normal end flag 206 of the memory 901 of the client computer 101 as a return value.

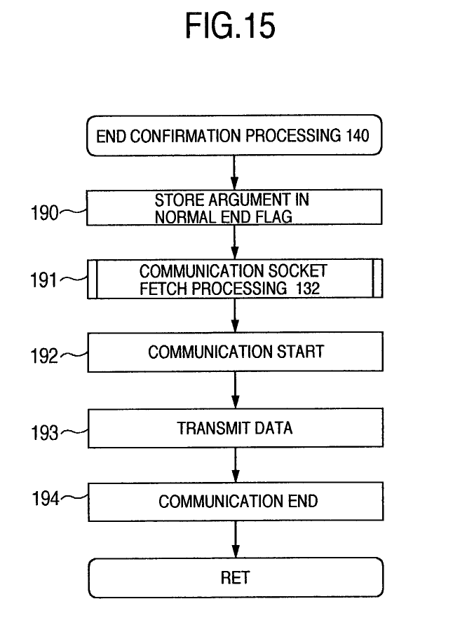

FIG. 15 shows a processing flow of the end confirmation processing 140 present in the memory 911 of the server computers 102a and 102b of FIG. 1 and is called from the application 131. The end confirmation processing 140 which has received as the arguments information on whether an error has occurred in the server computer and whether an abnormal end has occurred in the application operating in the server computer transmits the information to the client computer. Hereinafter, this procedure will be detailed.

Firstly, in step 190, the value passed as the aforementioned argument is stored in the normal end flag 215 of the memory 911 of the server computer 102a. Next, in step 191, the communication socket fetch processing 132 is called by using the communication protocol (TCP/IP) as the argument and a communication socket number is fetched. In step 192, communication is established by specifying a communication socket number, an IP address, and a port number. Furthermore, in step 193, a communication socket number, an address of the normal end flag 215, and a data length are specified and data transmission processing is executed. Thus, data stored in the normal end flag 215 is transferred via the NIA 912, the network 103, and the NIA 902 of the client computer to the normal end flag 206 of the memory 901 of the client computer 101. Furthermore, in step 194, communication with the client computer 101 is terminated.

As has been described above, the transmission data of the application of the client computer is stored in the communication buffer and information on whether an error has occurred in the server computer before termination of the application of the server computer and whether the application of the server computer has terminated normally is transmitted to the client computer. Accordingly, even if communication between the application of the server computer and the application of the client computer has terminated, data can be retransmitted to another server computer normally operating, thereby continuing the application of the client computer. This improves the availability of the system.

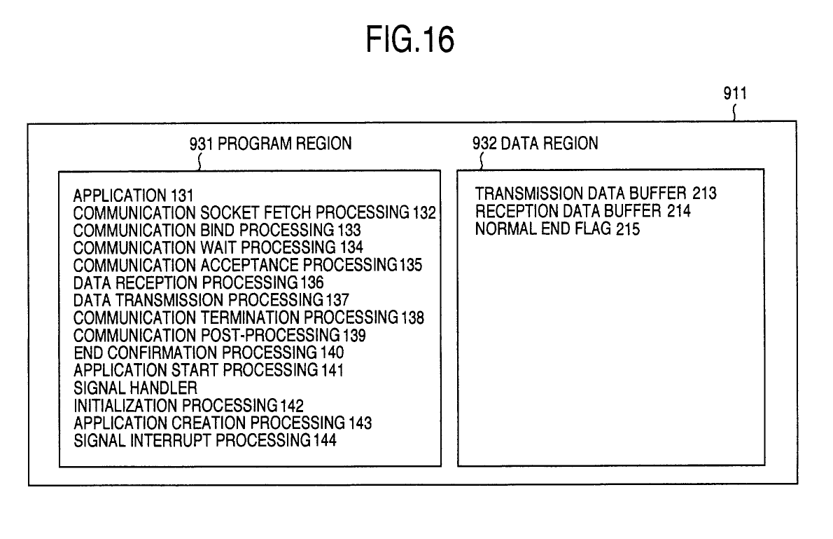

Description will now be directed to a second embodiment with reference to FIG. 16 to FIG. 19. Each of the server computers contains a program module for starting an application process for each communication of the application of the client computer, so that processes required by a plurality of client computers can be executed in a single server computer. The client computer and the server computer themselves are identical to those shown in the first embodiment of FIG. 1.

FIG. 16 shows configuration of the memory 911 of the server computer according to the second embodiment. The data region 932 stores the same contents as in the first embodiment explained with reference to FIG. 2. On the other hand, the program region 931 contains in addition to those processing modules explained in FIG. 2, an application start processing 141, a signal handler initialization processing 142, an application generation processing 143, and a signal interrupt processing 144.

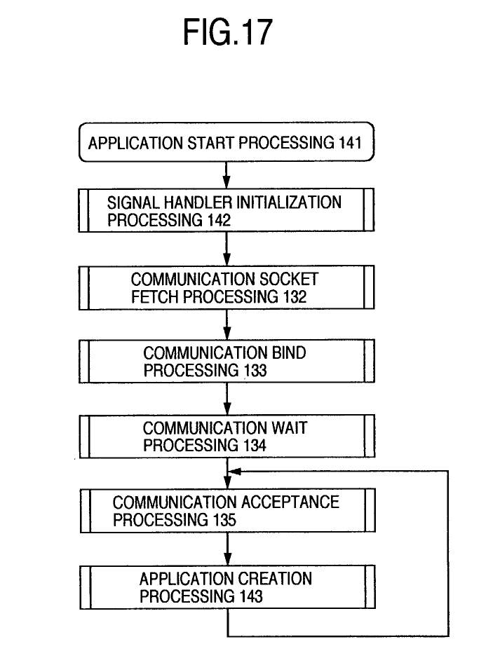

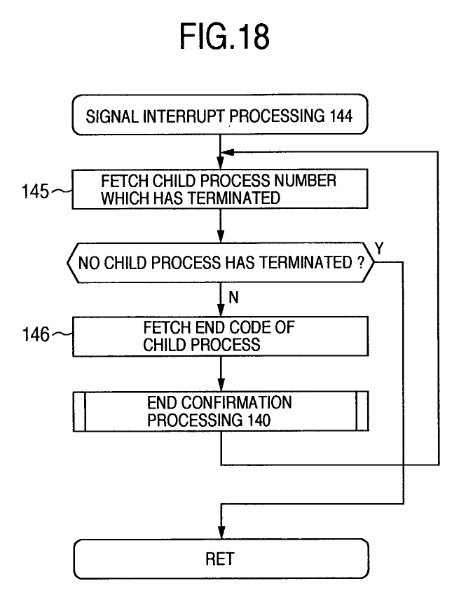

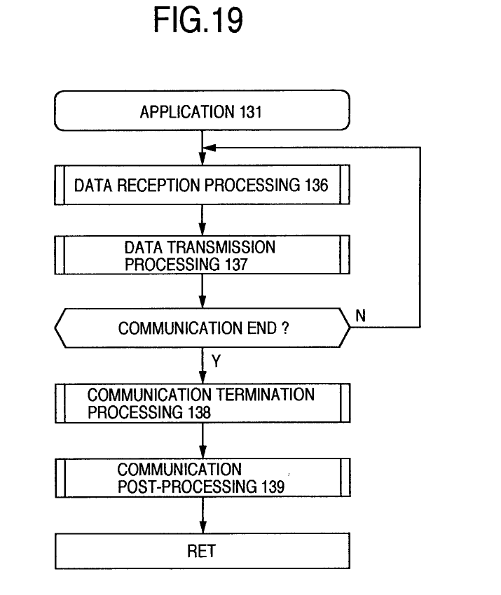

FIG. 17 shows the application start processing 141 executed in the server computer 102a and 102b according to the second embodiment and particularly related to the present invention. The application start processing 141 is a program module to start an application process for each communication of the application of the client computer. Firstly, the signal handler initialization processing 142 makes a setting, so that the signal interrupt processing 144 shown in FIG. 18 is started upon reception of a signal of a child process end. Next, when performing communication, the communication socket fetch processing 132 is called by using the communication protocol (TCP/IP) as the argument and a communication socket number is fetched so as to be used to specify a client computer with which communication is to be performed, an application, and a communication stream. To specify an IP address and a port number for performing reception, the communication bind processing 133 is called by using the communication socket number and the IP address as arguments. Furthermore, to perform a connection wait from the client computer 101, the communication wait processing 134 is called by using the socket number as the argument. Furthermore, the communication acceptance processing 135 is called and a connection-completed socket number with which connection with the client is complete is received as a return value. Furthermore, the application generation processing 143 generates a child process and the child process executes the application 1331 of FIG. 19. The parent process returns to the communication acceptance processing 135.

FIG. 19 shows the application 131 executed in the server computers 102a and 102b according to the second embodiment. In this embodiment, the application 131 is started as a child process of the application start process 141 which is a parent process. Firstly, in order to receive a processing content required by the client computer, the data reception processing 1136 is called by using as the argument the connection-completed socket number received from the application start processing 141 as the parent process, an address of the reception data buffer 214 of the memory 911 of the server computer 102a, and a data length to be received. When the data transmission processing 125 of the client computer 101 is executed and the data reception processing 136 is executed in the server computer 102a, data stored in the transmission data buffer 203 of the memory 901 of the client computer 101 is transferred via the NIA 902 of the client computer 101, the network 103, and the NIA 912 of the server computer 102a to the reception data buffer 214 of the memory 911 of the server computer 102a.

Furthermore, in order to transfer a result of processing executed in the server computer to the client computer, the data transmission processing 137 is called by specifying the connection-completed socket number, an address of the transmission data buffer 213 of the memory 911 of the server computer 102a, and data length stored in the transmission data buffer 213. When the data transmission processing is executed in the server computer 102a and the data reception processing 1126 of the client computer 101 is executed, data stored in the transmission buffer 2213 of the memory 911 of the server computer 102a is transferred via the NIA 912 of the server computer, the network 103, and the NIA 902 of the client computer 101 to the reception data buffer 204 of the memory 901 of the client computer 101.

The data reception processing 136 and the data transmission processing 137 are repeated as is required. When communication is performed a necessary number of times, in order to terminate the communication, the communication termination processing 138 is called by using the connection-completed socket number as the argument. After the communication termination processing 138 is complete, the communication post-processing 139 (see the first embodiment) is executed like in the first embodiment.

When the aforementioned processing is complete, the application 131 as the child process terminates processing with a process end value 0 if normal termination and non-0 if other than normal termination.

FIG. 18 shows the signal interrupt processing 144 executed in the server computers 102a and 102b according to the second embodiment and related to the present invention.

When the child process started by the application start processing 141, i.e., the application 131 is terminated, the signal interrupt processing 144 set in the application start processing 141 is called. Here, the signal interrupt processing checks an end code of the application 131 and transmits to the client, information on whether an error has occurred in the server computer and whether the application operating in the server computer has terminated abnormally. This procedure will be detailed below.

Firstly, the child process number terminated in step 145 is fetched. Simultaneously with this, an end status of the child process including the end code is also fetched. If there is no child process terminated in step 145, the signal interrupt processing 144 is terminated. Furthermore, in step 146, the end code of the child process is fetched from the end status. When the end code is 0, it means that the child process (application 131) has terminated normally. If the end code is other than 0, it means that the child process has terminated abnormally. To cope with this, the end confirmation processing 140 is called by using the end code of the child process obtained in step 146 as the argument and information on whether an error has occurred in the server computer and whether the application operating in the server computer has terminated abnormally is transmitted to the client computer.

As has been described above, the end code of the application of the server computer is fetched in the application start processing and transmitted to the client computer. Thus, without correcting the application of the server computer, it is possible to notify the client computer whether an error has occurred in the server computer before termination of the application of the server computer and whether the application of the server computer has terminated normally. In combination with the client computer according to the first embodiment, even if an error occurs in the server computer or the application of the server computer terminates abnormally, the application of the client computer can be continued, thereby improving availability.

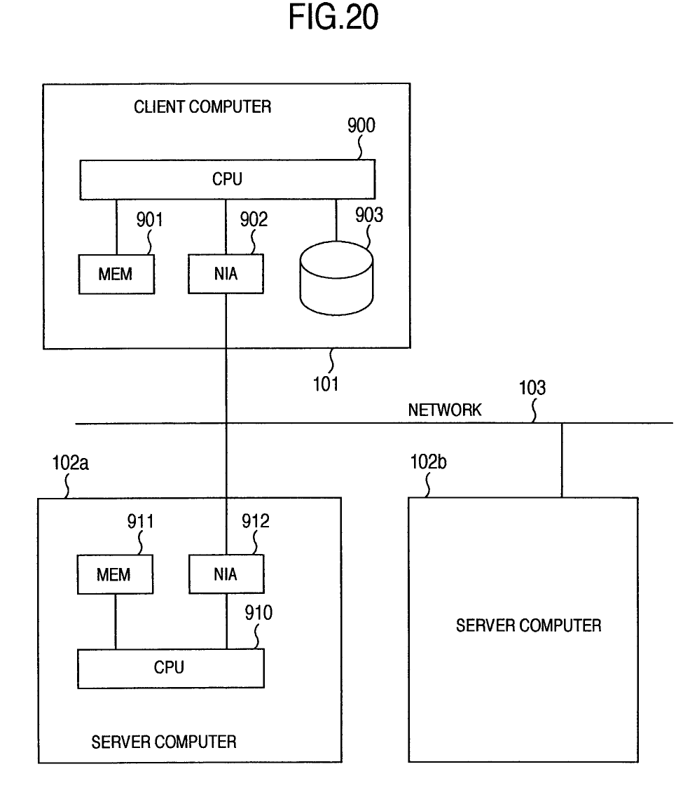

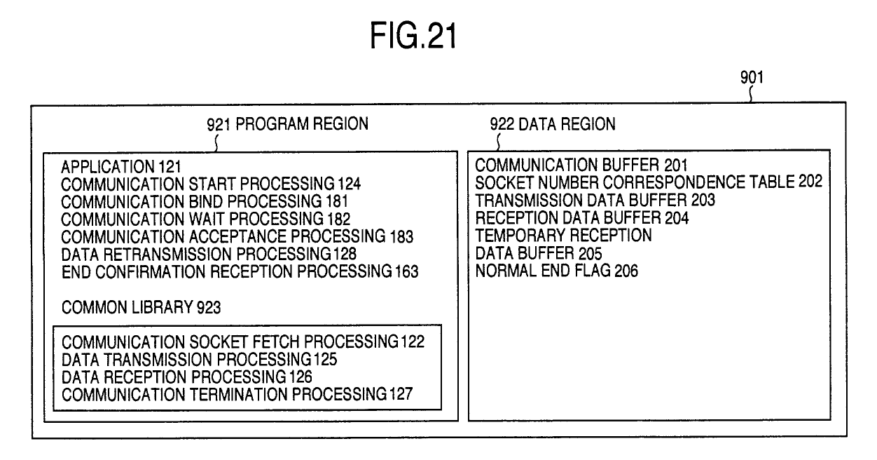

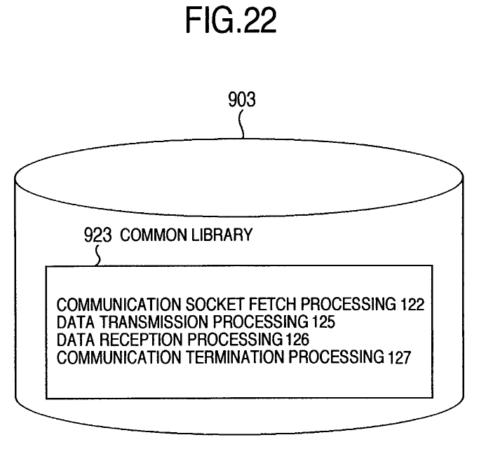

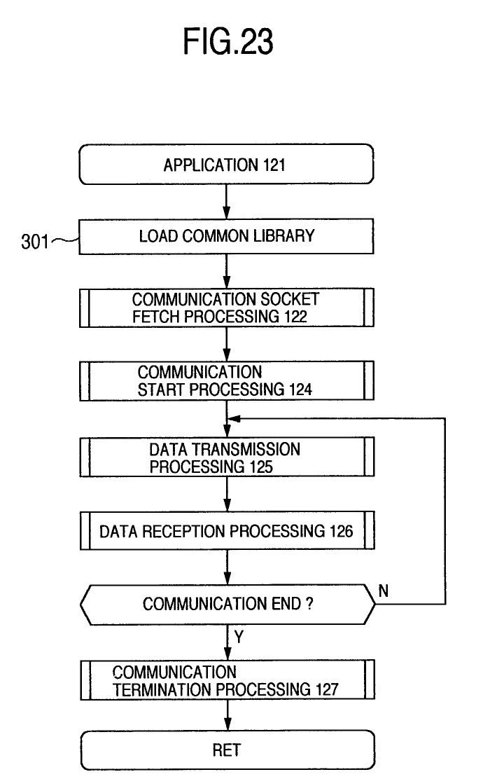

Description will now be directed to a third embodiment with reference to FIG. 20, FIG. 21, FIG. 22, and FIG. 23. This embodiment uses a library dynamically linked in the client computer. FIG. 20 shows configuration of the computer system, which is basically identical to FIG. 1. However, the client computer 101 includes a secondary storage device 903.

As shown in FIG. 21, in the program region 921 of the memory 901 of the client computer 101, the application 121, the communication start processing 124, the data retransmission processing 128, and the end confirmation reception processing 163 are stored in advance. The other processing modules stored in the first embodiment (FIG. 2), as will be detailed later, are loaded from a common library of the secondary storage device 903 to the program region 921 of the memory 901 upon execution of the application. Configuration of the data region 922 is completely identical to the data region (FIG. 2) of the memory 901 of the client computer 101 of the first embodiment.

As shown in FIG. 22, the secondary storage device 903 of the client computer 101 has a common library 923 dynamically loaded from the secondary storage device 903 to the program region 921 of the memory 901 upon execution of the application 121. The common library 923 contains the communication socket fetch processing 122, the data transmission processing 125, the data reception processing 126, and the communication termination processing 127.

FIG. 23 shows a processing flow of the application 121 executed in the client computer of the third embodiment. At start of the application, in step 301, the common library is loaded. Thus, the common library 923 of the secondary storage device 903 of the client computer 101 is loaded in the program region of the memory 901 of the client computer 101 and the communication socket fetch processing 122, the data transmission processing 125, the data reception processing 126, and the communication termination processing 127 can be called in the application 121. The processing flow after this is identical to that of FIG. 4.

In this embodiment, the communication socket fetch processing 122, the data transmission processing 125, the data reception processing 126, and the communication termination processing 127 which require modification in order to realize the present invention are stored in the common library in the secondary storage device. Accordingly, when creating an application, only by including the process of loading 301 of the common library of FIG. 23, the effect explained in the first embodiment can be obtained without correcting the processing modules on the program region of the memory 901. That is, transmission data of the application of the client computer is stored in the communication buffer and it is possible to receive information from the application of the server computer whether the application of the server computer has terminated normally. Furthermore, when the application of the server computer does not operate normally, data is retransmitted to another server computer operating normally, so that the application of the client computer can be continued. That is, without modifying the application 121, it is possible to improve the efficiency of the system. It should be noted that instead of the aforementioned four processing modules, some of them can be stored in the common library and it is possible to obtain the effect for that.

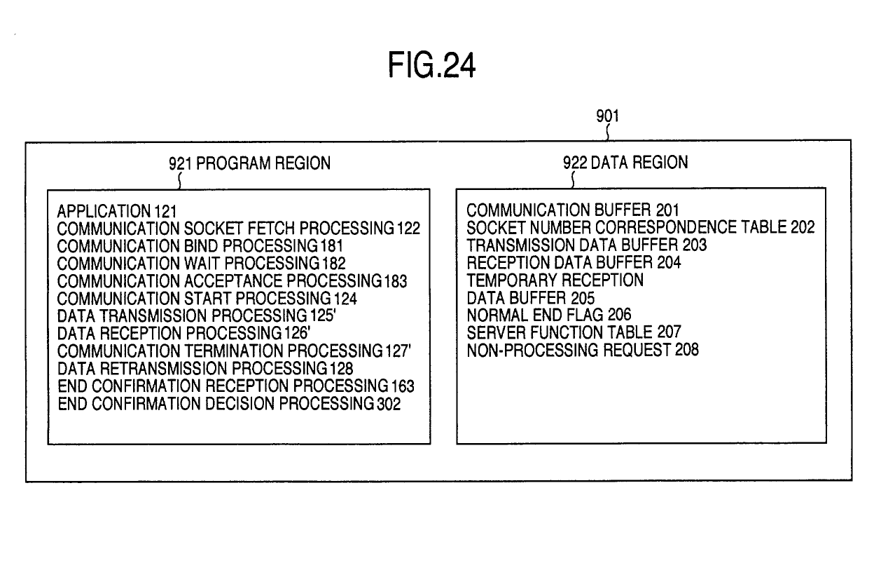

Description will now be directed to a fourth embodiment with reference to FIG. 24 to FIG. 29. The fourth embodiment differs from the aforementioned embodiments in that the client computer has a function to check whether a server computer has a function to report to the client computer that the application has terminated normally.

FIG. 24 shows configuration of the memory 901 of the client computer 101. The program region is different from the first embodiment in that it contains the end confirmation function check processing 302 for checking whether the server computer which is a communication mate identified by the communication socket fetch processing 1212 has a function to notify normal termination of the communication. Other details are similar to the first embodiment but the data transmission processing, the data reception processing, and the communication termination processing are slightly different from those detailed in FIG. 8, FIG. 9, and FIG. 10 and reference symbols 125′, 126′, and 127′ are used. The data region is different from the first embodiment in that it contains a server function table 207 used by the data transmission processing 125′, the data reception processing 126′, and the communication termination processing 127′ and a non-processing request 208 used by the aforementioned confirmation function check processing 302.

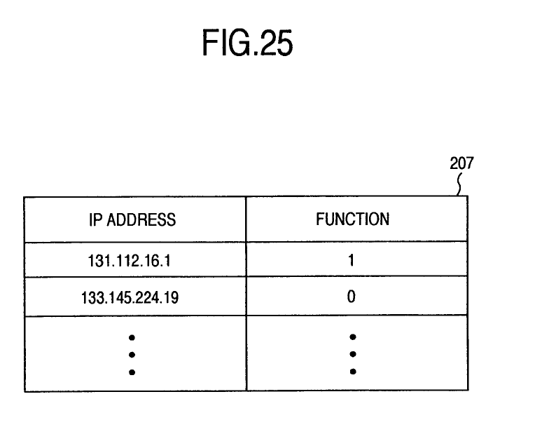

The server function table 207, as shown in FIG. 25, can store correspondence between the IP address and the flag indicating whether the function is present or absent. When the end confirmation processing 140 is contained in the application 131 executed in the server computer 102a as a communication destination of the application 121 of the server computer 101, the function for the IP address of the server computer 102a is indicated by the flag=1, and when the end confirmation processing is not contained, the function for the IP address of the server computer 102a is indicated by the flag=0.

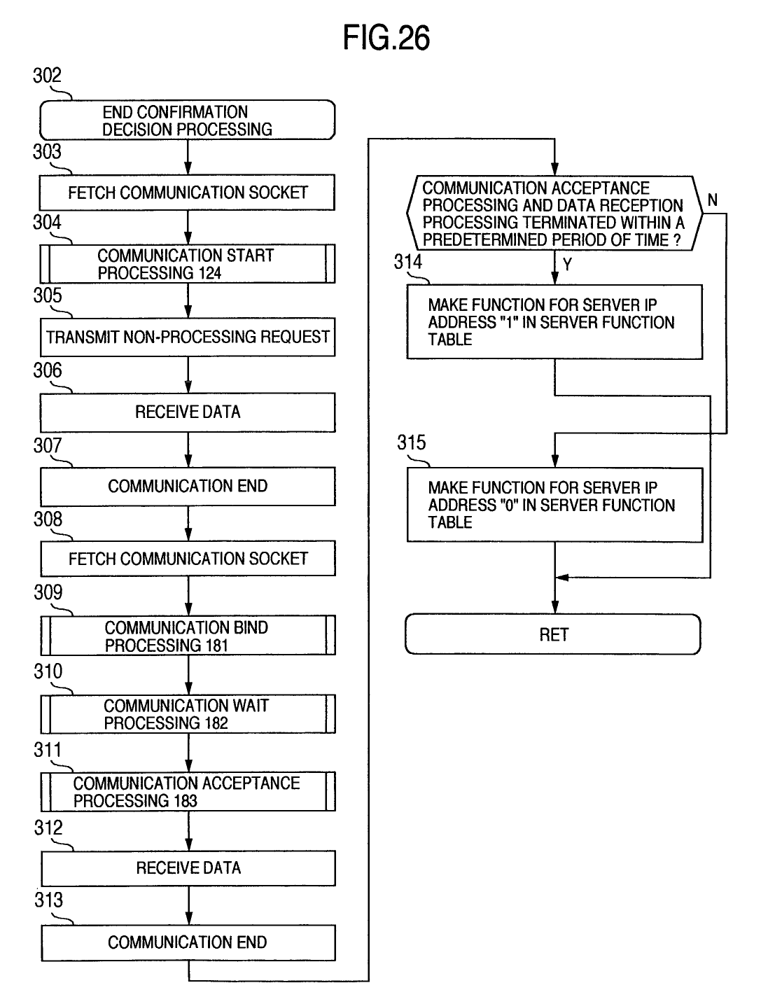

FIG. 26 shows a processing flow of the confirmation function check processing 302 present in the memory 901 of the client computer 101 and called from the data transmission processing 125′, the data reception processing 126′, and the communication termination processing 127′ of the client computer 101. The confirmation function check processing 302 transmits a “non-processing” as a request for not performing processing and receives a reply for this. After this, check is made whether reception from the end confirmation processing 140 of the server computer can be performed within a predetermined period of time. If reception is performed, the function for the IP address of the server computer is made “1” in the server function table. If reception cannot be performed, the function for the IP address of the server computer is made “0” in the server function table. This procedure will be detailed below.

Firstly, in step 303, a communication socket number is fetched. Next, in step 304, the communication start processing 124 (FIG. 7) is called by using the communication socket number, the IP address, and the port number as arguments, so as to establish a new communication with a server computer to be checked. Furthermore, in step 305, by specifying the communication socket number and the address and data length of the non-processing request of the memory 911 of the client computer 101, a non-processing request 208 is transmitted to the server computer 102a. The non-processing request is a request for performing “no processing” in the application 131 of the server computer. For example, for a mail server based on the smtp protocol, &quot;QUIT&quot; is a processing request for performing no processing. When the data reception processing 136 of the server computer 102a is executed, data of the non-processing request 208 is transferred via the NIA 902 of the client computer 101, the network 103, and the NIA 912 of the server computer 102a to the reception data buffer 214 of the memory 911 of the server computer 102a. In order to receive a reply for the “non-processing” request from the server computer, the client computer 101 performs in step 306, data reception processing by specifying the communication socket number and an address and data length of the temporary reception data buffer 205. Furthermore, in step 307, by specifying the socket number fetched, communication with the server computer is terminated.

Furthermore, in order to check whether a reply from the end confirmation processing 140 of the server computer 102a as an object can be received, communication with the server computer 102a is established again. For this, in step 308, the communication socket number is again fetched. Next, in step 309, in order to identify an IP address and a port number performing reception, the communication bind processing 181 is called by using the communication socket number, the IP address, and the port number as arguments. And in step 310, in order to perform connection wait from the server computer 102a, the communication wait processing 182 is called by using the communication socket number as the argument. Next, in step 311, the communication acceptance processing 183 is called and the IP address and the port number of the communication destination are fetched. Next, in step 312, in order to receive one word indicating whether terminated normally, a data reception processing is performed by specifying the socket number and the address and data length of the normal termination flag 206 of the memory 901. Furthermore, in step 313, by specifying the socket number fetched, communication with the server computer 102a is terminated. Here, if the communication reception processing 311 and the data reception processing 312 terminates within a predetermined period of time, the function for the IP address of the server is made “1” in the server function table 207. Otherwise, in step 315, the function for the IP address of the server is made “0” in the server function table 207.

In this embodiment, the processing flow of the application of the client computer 101 is identical to that of the first embodiment explained with reference to FIG. 4. However, the data transmission processing, the data reception processing, and the communication termination processing are slightly different from those in the first embodiment. These will be detailed below.

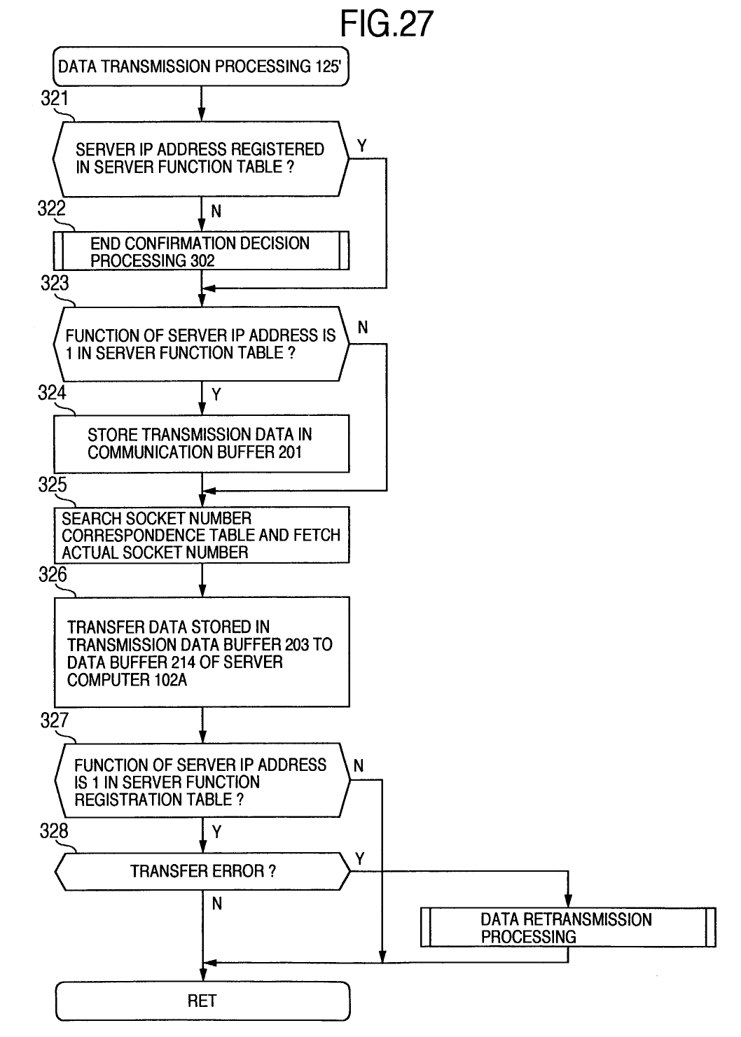

In the data transmission processing shown in FIG. 27, the communication socket number, the address of the transmission data buffer 203 of the memory 901 of the client computer 101, and the data length stored in the transmission buffer are received as arguments and a content of the transmission data buffer is transmitted by the data length of the data buffer to the application of a server computer specified by the communication socket number. Here, the content transmitted to the server computer is stored in the communication buffer 201. When the application of the server computer terminates abnormally, data can be transmitted to another server computer, so that communication of the application of the client computer can be continued. This procedure will be detailed below.

Firstly, in step 321, check is made whether the IP address of the server computer 102a is registered in the server function table 207. If not registered, in step 322, the end confirmation decision processing is called to perform registration. Next, in step 323, the server function table 207 is checked to determine whether the function of the server computer specified (here, 102a) is “1”. If the function is “1”, in step 324, transmission is stored in the transmission/reception division column of the communication buffer 201 of the memory 901 of the client computer 101, the data length specified by the argument is stored in the column of the transmission data length of the communication buffer 201, and data of the transmission data buffer 203 is stored in the column of the transmission data of the communication buffer 201. If the function of the specified server is “0”, i.e., if the specified server computer does not have the function to confirm that transmission has terminated normally and transmits the confirmation result to the client computer upon termination of data transmission from the client computer, then the storing of the transmission data in the communication buffer is skipped.

Next, in step 325, by using as a virtual socket number the communication socket number received as the argument, the socket number correspondence table 202 is searched to fetch an actual socket number. Furthermore, in step 326, data stored in the transmission data buffer 203 of the memory 901 is transferred to a server computer specified by the actual socket number. The data is transferred to the reception data buffer 214 of the memory 911 by the data reception processing 136 of the server computer 102a in the same way as in the first embodiment. Furthermore, in step 327, the server function table 207 is checked to determine whether the function of the IP address of the server computer 102a is “1”. If the function is “0”, the processing is terminated. If the function is “1”, control is passed to step 328, where check is made whether an error has occurred in the transfer in step 156. If an error has occurred, in order to transmit the content which has been transmitted, the data retransmission processing 128 is called.

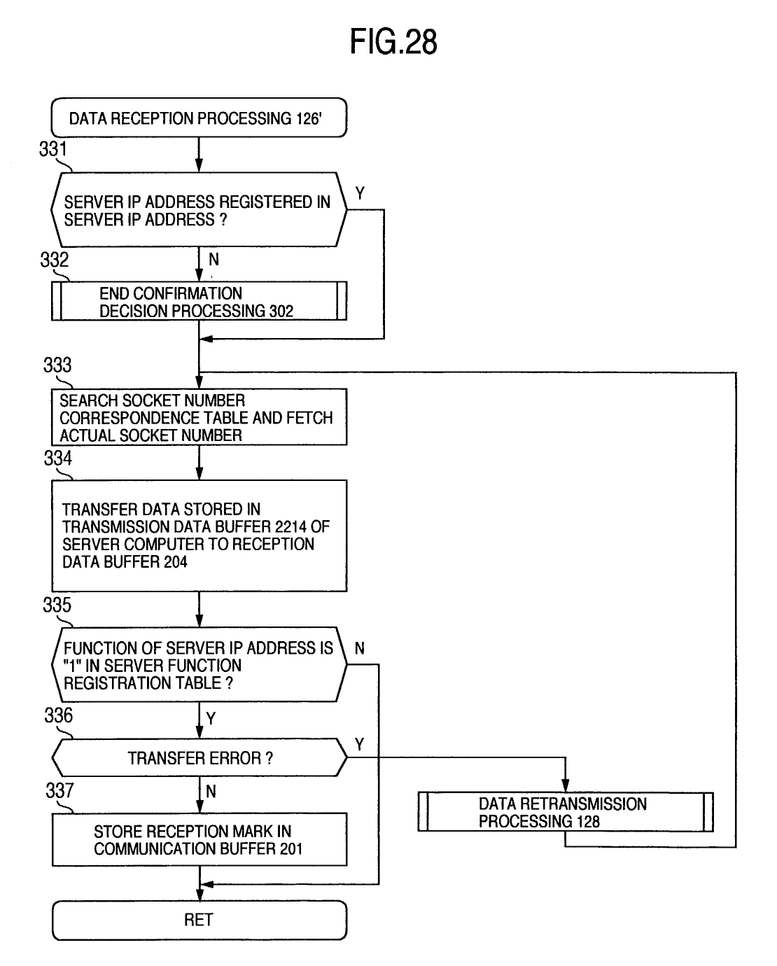

FIG. 28 shows a processing flow of the data reception processing 126′ called from the application 121. Firstly, in step 331, check is made to determine whether the IP address of the server computer 102a is registered in the server function table 207. If not registered, the IP address is registered by calling the confirmation function check processing 302 in step 332. Next, in step 333, the communication socket number received as the argument is used as a virtual socket number to search the socket number correspondence table and fetch an actual socket number. Furthermore, in step 334, the data transmission processing 137 of the server computer 102a specified by the actual socket number is executed and data stored in the transmission data buffer 214 of the memory 911 of the server computer 102a is transferred to the reception data buffer 204 of the memory 901 of the client computer 101. Furthermore, in step 335, check is made whether the function of the IP address of the server computer 102a is “1” in the server function table 207. Unless the function is “1”, the processing is terminated. If the function is “1”, control is passed to 336, where check is made whether an error has occurred in the transfer of step 334. When a transfer error has occurred, in order to transfer the content which has been transmitted, to another server, the data retransmission processing 128 is called and the data reception processing 126′ is performed from the beginning. When no transfer error has occurred, control is passed to step 337, where reception is stored in the transmission/reception division in the communication buffer 201.

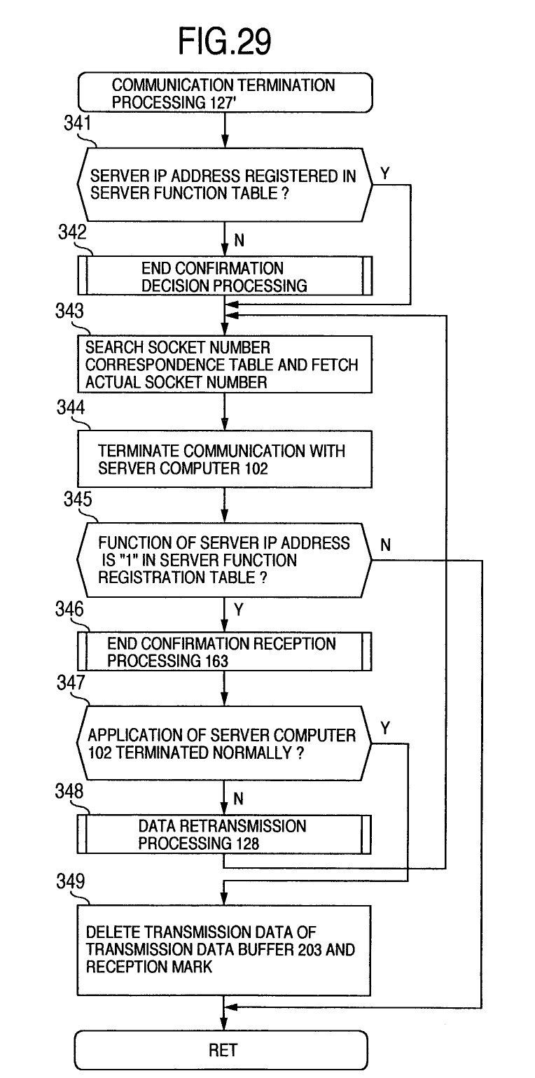

FIG. 29 shows a processing flow of the communication termination processing 127′ called from the application 121 of the fourth embodiment. Here, also, firstly, in step 341, check is made to determine whether the IP address of the server computer 102a is registered in the server function table 207. If not registered, in step 342, the confirmation function check processing 302 is called to register it. Next, in step 343, the communication socket number received as the argument is used as a virtual socket number to search the socket number correspondence table and fetch an actual socket number. Next, communication with the server computer 102 corresponding to the actual socket number is terminated. Furthermore, in step 335, check is again made whether the function of the IP address of the server computer is “1” in the server function table 207. Unless the function is “1”, the processing is terminated. If the function is “1”, control is passed to step 346, where the end confirmation reception processing 163 is called to receive from the end confirmation processing 140 of the server computer 102, information on whether the application has terminated normally. If the end confirmation reception processing 163 returns “0” (the application has terminated normally) as a return value, control is passed to step 349, where the transmission/reception division, the transmission data length, and the transmission data stored in the communication buffer 201 are deleted. If the end confirmation reception processing 163 returns other than “0” (the application has not terminated normally) as a return value, then in step 348, the data retransmission processing 128 is called and the processing is executed from step 343.

As has been described above, the confirmation function check processing 302 checks whether the server computer has the end confirmation processing 137. Accordingly, in a system including a server having no end confirmation processing 137 and a server having the end confirmation processing 137, when operating in a server computer, if an application of the server computer has terminated abnormally, data can be retransmitted to another server computer operating normally, thereby continuing the communication. This improves the system efficiency.

Since the present invention has the aforementioned configuration, it is possible to improve the efficiency of the server-client system as will be detailed below.

Firstly, data transmitted by an application of a client computer is stored and information on whether an application of a server computer terminates normally is transmitted to the client computer. When the application does not terminate normally, the data stored in the server computer is retransmitted. Thus, even when an error has occurred in the server computer, processing of the client computer can be continued.

The second effect is obtained by that in the processing to start an application of a server computer, it is decided whether the application of the server computer terminates normally and the decision result is transmitted to a client computer. Thus, without modifying the application of the server computer, even if an error has occurred in the server computer, processing of the client computer can be continued.

The third effect is obtained by that a library dynamically linked stores data transmitted by the application of the client computer and performs retransmission processing when an error has occurred in the server computer. Thus, without modifying the application of the client computer, processing of the client computer can be continued even if an error has occurred in the server computer.

The fourth effect is obtained by that check is made to determine whether a server computer has a mechanism to report to a client computer that an application of the server computer has terminated normally. Thus, it is possible to constitute a system by using a server having this mechanism and a server not having this mechanism. Furthermore, if the server computer where an error has occurred has this mechanism, the processing of the client computer can be continued.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A server-client data transfer method in a computer system comprising at least two server computers executing an identical application and a client computer connected to the server computers via a network and executing an application performing communication with the server computers, the method comprising steps of:
executing a communication start processing so as to establish an application-to-application communication between one application in the server computer and an application of the client computer; and
transferring transmission data from the application of the client computer to the application of the server computer and storing the transmission data in a transfer buffer of the client computer,
wherein upon completion of transfer of a predetermined number, the server computer and the client computer execute termination of the application-to-application communication,
after termination of the application-to-application communication, the server computer executes a communication post-processing, terminates the application of the server computer, executes an end confirmation processing to check whether the application has terminated normally, and reports the check result to the client computer,
when the check result indicates a normal termination of the application, the client computer deletes the communication data from the communication buffer and when the check result does not indicate a normal termination of the application, a retransmission processing is executed to retransmit the transmission data stored in the communication buffer to another server.

2. The server-client data transfer method as claimed in claim 1, wherein the communication start processing includes a step of recording a correspondence between a virtual socket number used by the application of the client computer and an actual socket number of the application-to-application communication in a socket number correspondence table in the client computer and the retransmission processing modifies the actual socket number of the socket number correspondence table to a new socket number fetched upon the retransmission processing.

3. The server-client data transfer method as claimed in claim 1, wherein the server computer includes an application start processing for monitoring a communication request for a port number specified for the application and starting the application as a child process when a communication request is made from the client, and the end confirmation processing is executed upon termination of the child process started.

4. The server-client data transfer method as claimed in claim 1, wherein the client computer has an end confirmation decision processing for deciding whether the server computer has the function of the end confirmation processing and recording the decision result, and prior to transmission of the transmission data, reads out the decision result of the server computer as the transmission destination and only if the decision result indicates that the function is provided, writes the transmission data in the communication buffer.

5. The server-client data transfer method as claimed in claim 4, wherein upon termination of the application-to-application communication, the client computer reads out the decision result of the server computer as the transmission destination and only if the decision result indicates that the function is provided, the client computer waits for the application end confirmation processing from the server computer.

6. The server-client data transfer method as claimed in claim 4, wherein the decision whether the end confirmation processing is provided is performed by transmitting a non-processing request from the client computer to the server computer to determine whether in response to the non-processing request, normal termination is reported from the server computer as the transmission destination.

7. A server-client system comprising at least two server computers executing an identical application and a client computer connected to the server computers via a network and executing an application performing communication with the server computers,
wherein each of the server computers has: an end confirmation processing to report to the client whether the application performing communication with the client computer has terminated normally; a communication socket fetch processing for fetching a socket number used for communication to the client computer; a communication bind processing for establishing connection with the client computer by using the socket number; a communication wait processing; a communication acceptance processing; a data transmission processing for performing transmission to the client computer; a data reception processing for performing reception from the client computer; a communication termination processing for terminating the communication with the client computer; and an application having a communication post-processing performed upon termination of the communication with the client,
while the client computer has: a communication buffer for recording communication to the server computer; a socket number correspondence table recording a socket number used for communication with the server computer; a communication socket fetch processing for fetching a socket number used for communication with the server computer; a communication start processing for establishing a connection with the server computer by using the socket number; a data transmission processing and a data reception processing performing recording in the communication buffer when performing transmission and reception to/from the server computer; a retransmission processing used when the application of the server computer has not terminated normally for retransmitting communication data recorded in the communication buffer, to a server computer where the error has not occurred; and a communication termination processing for terminating the communication with the server computer, and
when the application of the server computer has terminated normally, the communication termination processing erases the communication data recorded in the communication buffer.

8. The server-client system as claimed in claim 7, wherein the client computer has at least one of the communication socket fetch processing, the data transmission processing, the data reception processing, and the communication termination processing implemented in a common library of the client computer.
